(19) United States
(12) Patent Application Publication
(10) Pub. No.: US 2004/0032880 A1
(43) Pub. Date: Feb. 19, 2004

(54) Provision of operational definitions in a wireless communication system

(76) Inventors: Nikolai K.N. Leung, Takoma Park, MD (US); Chung-Jen Tseng, Gaithersburg, MD (US)

Correspondence Address: Qualcomm Incorporated, Patents Department, 5775 Morehouse Drive, San Diego, CA, 92121-1714, US

(21) Appl. No.: 10/218,431

(22) Filed: Aug. 13, 2002

(51) Int. Cl. H04J 3/16; H04Q 7/00

(52) U.S. Cl. 370/466; 370/469; 370/328

(57) ABSTRACT

A wireless configurable radio application. When a wireless device requests a wireless service, the carrier network identifies protocol versions required for the service. A protocol version list is then provided to the wireless device. The wireless device requests any protocol versions not currently resident in the wireless device. The carrier network provides such protocols and the wireless device implements the protocols.

### BACKGROUND

1. Field

The present invention relates generally to Operational Definitions In A Wireless Communication System, and specifically to methods of configuration.

2. Background

A cellular or wireless communication device operates according to multiple protocols and operational definitions. When a wireless device is manufactured, such protocols and definitions are typically pre-configured into the device. As new services and operations develop, older devices may become obsolete. Older devices are, therefore, either taken to the service provider to be reprogrammed or are discarded.

Often the implementation of new definitions and/or protocols involves only a small portion of the device circuitry. In this case, minor modifications to software may result in extended applicability of the wireless device.

There is therefore, a need for a method of configuring a wireless device to implement new definitions and/or protocol. Further, there is a need for a method of wireless download of such definitions and/or protocol.

### BRIEF DESCRIPTION OF THE DRAWINGS

FIG. 1 is an architectural description of a wireless communication system.

FIG. 2 illustrates a protocol library within a wireless communication device.

FIG. 3 is a timing diagram of a process for configuring operational definitions and/or protocol within a wireless device.

FIG. 4 is a flow chart for configuring operational definitions and/or protocol within a wireless communication device.

FIG. 5 is a wireless communication device.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

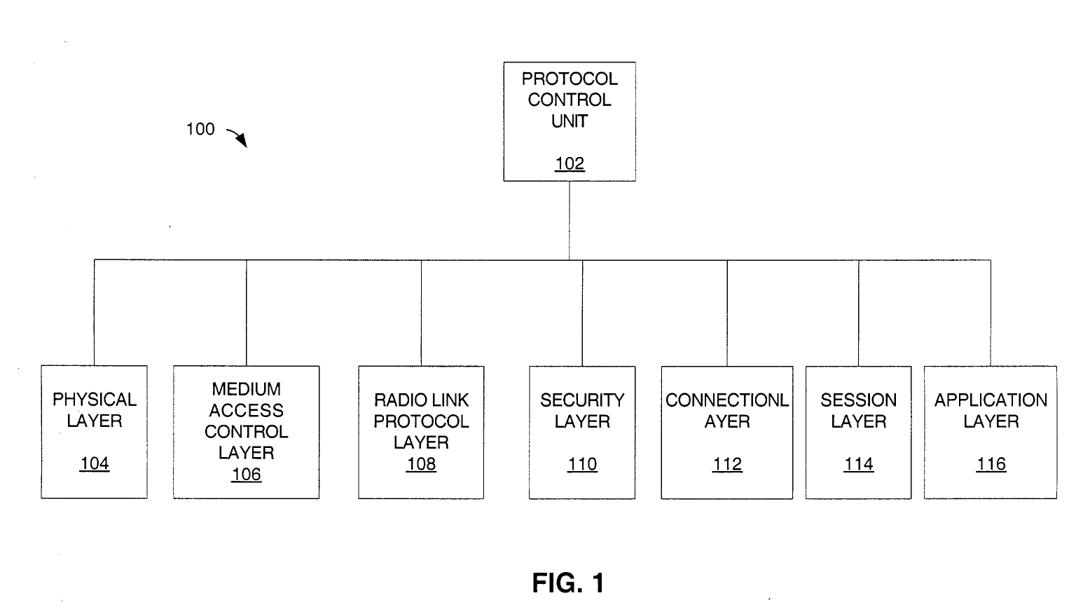

FIG. 1 illustrates an architectural description of a wireless communication system 100. The system 100 includes physical layer 104, which provides the channel structure, frequency, power output, modulation, and encoding specifications for both forward and reverse link channels. The system 100 also includes a medium access control layer 106, referred to as MAC. The MAC layer defines the procedures used to receive and to transmit over the physical layer. The system 100 also includes a radio link protocol layer 108, a security layer 110, a connection layer 112, and a session layer 114. As illustrated, a protocol control unit 102 controls operation of each of the various layers. The radio link protocol layer is also referred to as RLP. The security layer 110 provides authentication and encryption services. The connection layer 112 provides air link connection establishment and maintenance services. The session layer 114 provides address management, protocol negotiation, protocol configuration, and state maintenance services. Additionally, the application layer 116 is illustrated for completeness. . Alternate embodiments may include any number of layers and/or a combination of the layers illustrated in FIG. 1. Protocol control unit 102 identifies the current versions for the protocols and/or operational definitions of each of the various layers. Further, protocol control unit 102 is responsible for updating the versions of each of these layers. Updating may involve rewriting common memory to provide a newer version of the protocol or may involve creating a library of various versions for each protocol.

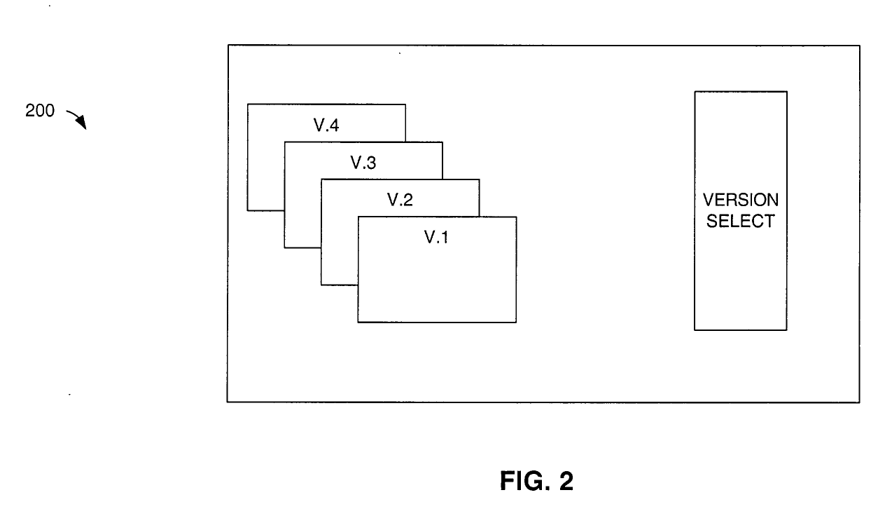

FIG. 2 illustrates a protocol library 200 located within a wireless communication device. As illustrated, the protocol library 200 includes multiple versions of the protocol. A version select unit is provided to select among the versions stored within protocol library 200. For example the protocol library 200 may store versions of the RLP 108. In this case, depending on the service selected version select will select the appropriate version of the RLP operational definitions.

The wireless communication device may be a cellular telephone, a Personal Digital Assistant (PDA), a pager, a computer adapted for wireless communication, etc. Communication in a wireless communication system is via a carrier network. The carrier network controls messages, generally in the form of data packets, sent to a Mobile Switching Center (MSC) (not shown). The MSC is then in communication with multiple Base Stations (BSs) (not shown) which ultimately broadcast communications to the wireless devices.

When an end-user of the wireless device desires to access a given service, such as to select a packet data service option, the user attempts to connect via the carrier network. The carrier network then determines the protocols and protocol versions required for the given service. The carrier network sends a message to the wireless device indicating the protocols and protocol versions required. Such protocols may include any layer in the architecture of a given wireless communication system. In response to the message from the carrier network, the wireless device determines if any required protocols are missing, and requests any missing protocols from the carrier network. The wireless device also evaluates existing protocols to verify that the required version is currently stored in the wireless device. The carrier network responds to the request by sending the protocols and versions requested. Note that there may be optional protocols and/or versions that are available for a given service. For example, an optional version may provide enhanced encryption but incur delays in operation or require significant memory to store. The wireless device determines whether to request an optional protocol and/or version, and if the options are desired, requests the options in a similar manner.

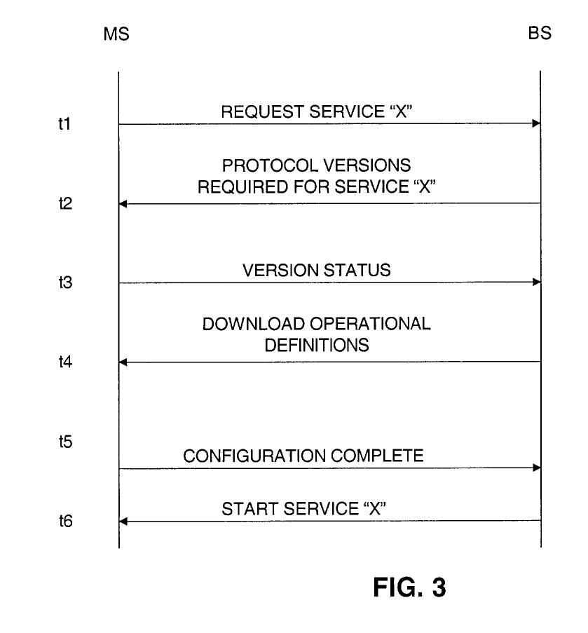

FIG. 3 is a timing diagram of an operation for configuring a wireless communication device with new versions of various protocols and/or operational definitions. A time t1, the mobile station (MS) requests a given service from the base station (BS). For example the service may be a packet service. In response, the base station determines the protocol versions required to support the service. The protocol versions required are provided to the mobile station over the air link at time t2. The mobile station then determines the status of the versions for each protocol within the protocol library. At time t3 the mobile station sends a version status message back to the base station. The version status message identifies the version for each protocol required for service X as available or not. In one embodiment the mobile station only sends back a version status message for those versions not available at the mobile station. The base station receives the version status message and in response transmits operational definitions for each of the versions that are not available at the mobile station. At time t5 the mobile station indicates that the configuration is complete. Service starts at time t6.

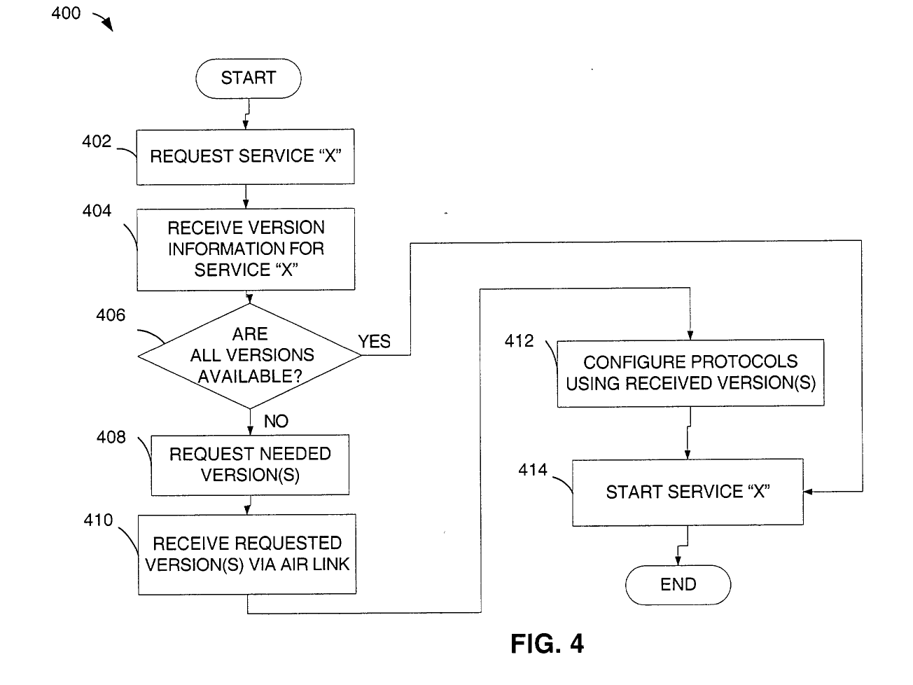

FIG. 4 is a flow diagram of a process 400 for wireless radio configuration in a communication device. The process starts step 402 when the mobile station requests a service. At step 404 the mobile station receives the version information for the requested service. At decision diamond 406 the mobile station determines that all versions are available. If the mobile station has, all versions available processing continues to step 414 to start the service. If the mobile station requires version updates such updates are requested at step 408. The mobile station then receives the requested versions via an air link at step 410. The mobile station configures the protocols using the received versions at step 412. At step 414 the service begins.

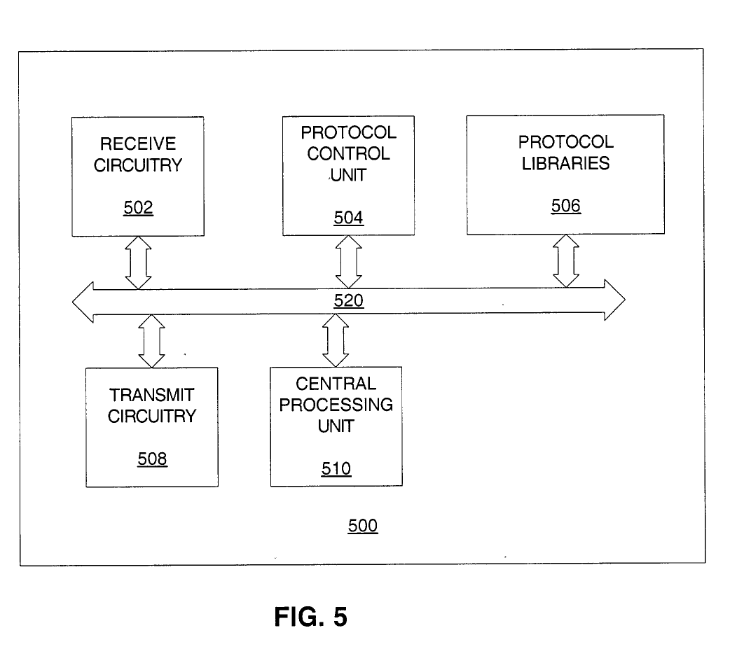

FIG. 5 illustrates a wireless communication device 500, including receive circuitry 502, transmit circuitry 508, protocol control unit 504, protocol library 506, and central practicing unit 510. The various modules within device 500 communicate via a communication bus 520. The protocol libraries 506 store the protocols supporting the architecture of FIG. 1. Note that alternate embodiments may store the protocols in multiple libraries, or individually. The protocol version information from the carrier network is received via the receive circuitry 502 and processed by central processing unit 510. The protocol control unit receives the protocol version information from the central processing unit 510 and compares the information to that currently available in the protocol libraries 506. The protocol information stored in the protocol libraries is accessed for implementation of the various layers of the architecture illustrated in FIG. 1. Alternate embodiments may implement alternate architectures, wherein the illustrated layers are provided as a modules according to function for clarity of understanding.

When the protocol control unit 504 identifies a protocol and/or protocol version that is not available in the protocol libraries 506, i.e., not currently supported by the wireless device 500, the protocol control unit 504 generates a request to the carrier network to receive such protocols. Upon receipt of the requested protocols the protocol control unit 504 incorporates the received protocols into the protocol libraries 506. The protocol control unit 504 may be a control program implemented in software, firmware, hardware, etc.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or-combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for configuring a wireless communication device, the wireless communication device having a protocol library, the method comprising:
requesting a wireless service;
receiving protocol version information associated with the wireless service, the protocol version information transmitted via a wireless connection; and
implementing the protocol version information to the protocol library.

2. The method as in claim 1, further comprising:
receiving a list of protocol versions associated with the wireless service;
comparing the protocol version list with the protocol library; and
requesting any protocol version on the protocol version list that is not in the protocol library.

3. The method as in claim 2, wherein the protocol version information includes operational definitions associated with the wireless service.

4. The method as in claim 2, wherein implementing the protocol version information comprises:
storing the protocol version information in the protocol library; and
creating an identifier for the location of the protocol version information in the protocol library.

5. A method for providing configuration information to a wireless communication device, the method comprising:
receiving a request for a wireless service;
determining a protocol version list associated with the wireless service; and
transmitting the protocol version list via a wireless connection.

6. The method as in claim 5, further comprising:
receiving a protocol version request list; and
transmitting protocol version information via the wireless connection.

7. A wireless communication device, comprising:
a processing unit;
a protocol library for storing operational definitions of a plurality of protocols, each of the operational definitions identified having a corresponding protocol version, each of the operational definitions identified by one of the plurality of protocols and the corresponding protocol version; and
a protocol control unit for comparing a protocol version list for a wireless service to the protocol library, and updating the protocol library in response thereto.

8. The wireless communication device as in claim 7, wherein the plurality of protocols includes a radio link protocol.

9. The wireless communication device as in claim 7, wherein the plurality of protocols includes a medium access control protocol.

10. The wireless communication device as in claim 7, wherein the protocol control unit determines if a protocol version is current or if an update is required.

11. The wireless communication device as in claim 7, wherein the processing unit facilitates a data service using the updated protocol library.

12. The wireless communication device as in claim 11, wherein the processing unit

13. An apparatus having a protocol library, the apparatus comprising:
means for requesting a wireless service;
means for receiving protocol version information associated with the wireless service, the protocol version information transmitted via a wireless connection; and
means for implementing the protocol version information to the protocol library.

14. An apparatus for providing configuration information to a wireless communication device, the apparatus comprising:
means for receiving a request for a wireless service;
means for determining a protocol version list associated with the wireless service; and
means for transmitting the protocol version list via a wireless connection.
